(19) United States
(12) Patent Application Publication
(10) Pub. No.: US 2020/0023833 A1
(43) Pub. Date: Jan. 23, 2020

(54) MOTOR VEHICLE PARKING ASSIST METHOD AND SYSTEM

(71) Applicant: RENAULT s.a.s., Boulogne-Billancourt (FR)

(72) Inventors: Guillaume MARTIN, Versailles (FR); Pape Abdoulaye SENE, Versailles (FR); Sebastien SALIOU, Rennes (FR)

(73) Assignee: RENAULT s.a.s., Boulogne-Billancourt (FR)

(21) Appl. No.: 16/491,291

(22) PCT Filed: Mar. 8, 2018
(86) PCT No.: PCT/FR2018/050531

§ 371 Date: Sep. 5, 2019

(30) Foreign Application Priority Data
Mar. 8, 2017 (FR) FR1751873

(51) Int. Cl. B60W 30/06; B60W 10/06; B60W 10/18

(52) U.S. Cl. CPC B60W 30/06; B60W 10/06; B60W 10/18; B60W 2710/18; B60W 2720/106; B60W 2710/0666; B60W 2550/20

(57) ABSTRACT

A motor vehicle parking assist system is for parking the vehicle moving from a traffic lane towards a vacant parking space and leaving the parking space to move towards the traffic lane. The parking assist system includes a module for determining the vehicle acceleration, which module is suitable for delivering a set point value for acceleration depending on the vehicle speed and on the distance from an obstacle and a torque regulating module suitable for calculating a set point value for braking torque and a set point value for engine torque depending on the set point value for acceleration, the vehicle speed, and for the road gradient.

The present invention relates to the field of motor vehicle driving aids, and in particular to parking aids.

More particularly, the invention relates to methods and systems for assisting completely automated parking in order to perform parking maneuvers, for example parallel parking maneuvers.

Such parking assistance methods and systems make it possible to detect a parking space and then take control over the electric power steering of the vehicle so as to perform the parking maneuver. The operation of steering the wheels for the purpose of the parking maneuver is thus performed completely automatically.

The driver of the vehicle remains responsible for changing gear, for accelerating and for braking the vehicle.

Document WO 2014/167255-A1 (Renault) discloses a trajectory-planning method for performing an automated parking maneuver for a motor vehicle. However, such a method does not take into account the longitudinal speed of the vehicle.

Reference may also be made to document WO 2014/191209-A1 (Renault), which describes a method for delegating parking maneuvers of the vehicle to an automated system.

In such methods, the acceleration is the sole responsibility of the driver. There is then a risk of the vehicle traveling at an excessive speed, which may lead to a collision with fixed or mobile obstacles situated in the proximity of the vehicle. In addition, the obstacle detection, the braking and the stopping of the vehicle are also under the exclusive control of the driver.

There is a need to improve driving assistance methods and systems in order to offer the driver the safest possible parking aid.

The object of the present invention is therefore that of providing a parking assistance system and method that are capable of taking into account the dispersion of the actuators, in particular of the braking systems, while at the same time ensuring that the vehicle is kept on an inclined road without influencing the precision of the control.

One subject of the invention is a parking assistance system for a motor vehicle allowing the vehicle to be parked from a traffic lane into an available parking space and allowing it to leave said parking space to move onto the traffic lane, said motor vehicle comprising an obstacle detection system, a parking space detection system, steering angle-controllable electric power steering, a torque-controllable engine and braking system, an automatic transmission or what is known as a “shift-by-wire” system, at least one odometric sensor, an accelerometer, a visual and audio interface and a means for activating an automatic control function.

The parking assistance system comprises a module for determining or calculating the acceleration of the vehicle, able to deliver an acceleration setpoint on the basis of a speed setpoint of the vehicle and of the distance to an obstacle and a torque control module able to calculate a braking torque setpoint and an engine torque setpoint on the basis of the acceleration setpoint, of the speed of the vehicle and of the gradient of the road.

The system makes it possible to control the movement of the vehicle at low speed. To this end, it has a low-speed speed estimator and an acceleration estimator.

Such a parking assistance system allows the driver to park more easily, taking into account not only the control over the lateral actuators, such as the electric power steering, but also over the longitudinal actuators, such as the engine, the transmission and the braking system of the vehicle, while leaving the driver the possibility of acting on the parking maneuver at any time.

According to one embodiment, the system comprises four operating states:
an initial state corresponding to the phase of searching for a parking space by way of the parking space detection system,
a first state corresponding to a phase of waiting for the start of the maneuver, in which the acceleration determination module calculates a negative acceleration setpoint so as to ensure that the vehicle is kept at a standstill, taking into account the road,
a second state corresponding to an acceleration cancellation phase, in which the acceleration determination module calculates a first acceleration setpoint in accordance with a fast decrease ramp and a second acceleration setpoint in accordance with a slow decrease ramp,
a third state in which the acceleration determination module calculates an acceleration setpoint on the basis of a feedforward filter and of a proportional integral controller, and
a fourth state corresponding to the braking activation phase, in which the acceleration determination module calculates an acceleration setpoint on the basis of a gain and of a braking ramp.

Thus, in each state of the parking maneuver, the acceleration determination module calculates an acceleration setpoint.

Advantageously, the torque control module comprises a module for calculating initial torque on the basis of the acceleration setpoint calculated by the acceleration determination module in each state of the parking maneuver.

For example, the initial torque calculation module comprises a converter for converting the value of the acceleration setpoint into a torque setpoint at the wheel on the basis of the speed of the vehicle and of the gradient of the road estimated using the information supplied by the accelerometer of the vehicle.

The initial torque calculation module may also furthermore comprise a saturator delivering, at output, a positive component corresponding to the initial engine torque setpoint and a subtractor able to subtract the positive component from the torque setpoint at the wheel in order to obtain the initial braking torque setpoint.

Advantageously, the torque control module comprises a deceleration control module activated only during interruption phases of the parking maneuver, such as the presence of obstacles on the trajectory, the driver canceling the maneuver or the failure of the actuators other than the braking system. Said deceleration control module is able to send bypass orders and to calculate a braking torque setpoint when an interruption is detected.

For example, the torque control module comprises a final torque setpoint calculation module capable of arbitrating between the various torque setpoints that it receives at input so as to deliver a final engine torque setpoint to the wheel and a final braking torque setpoint to the wheel.

According to a second aspect, the invention relates to a parking assistance method for a motor vehicle allowing the vehicle to be parked from a traffic lane into an available parking space and allowing it to leave said parking space to move onto the traffic lane, said motor vehicle comprising an obstacle detection system, a parking space detection system, steering angle-controllable electric power steering, a torque-controllable engine and braking system, an automatic transmission or what is known as a “shift-by-wire” system, at least one odometric sensor, an accelerometer, a visual and audio interface and a means for activating an automatic control function.

In the method, an acceleration setpoint is calculated on the basis of the speed of the vehicle and of the distance to an obstacle, and a braking torque setpoint and an engine torque setpoint are calculated on the basis of the acceleration setpoint, of the speed of the vehicle and of the gradient of the road.

For example, to calculate a braking torque setpoint and an engine torque setpoint, an initial engine torque setpoint and an initial braking torque setpoint are calculated on the basis of the acceleration setpoint and of the gradient of the road, it is checked whether there is an interruption of the parking maneuver, and a final engine torque setpoint and a final braking torque setpoint are calculated on the basis of the initial torque setpoints and of the detection of the interruption.

Other aims, features and advantages of the invention will become apparent upon reading the following description, given solely by way of nonlimiting example and with reference to the appended drawings, in which:

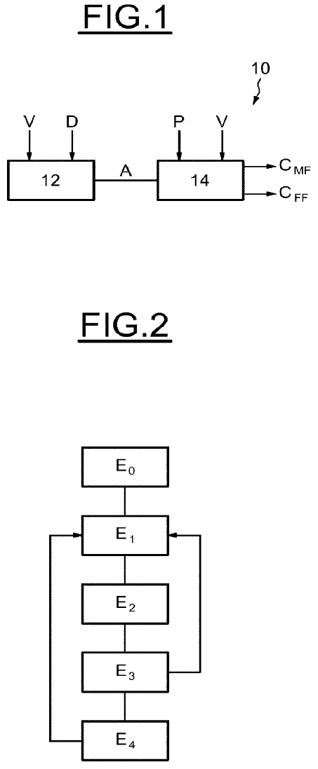

FIG. 1 schematically shows a parking assistance system for a motor vehicle according to the invention;

FIG. 2 illustrates the states of the parking assistance system according to FIG. 1;

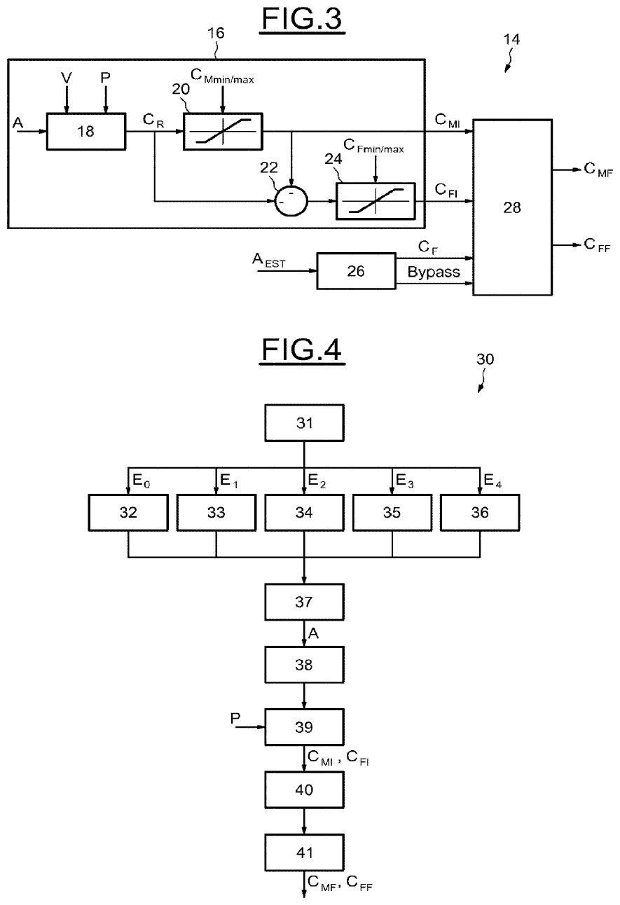

FIG. 3 illustrates, in detail, the torque control module of the parking assistance system of FIG. 1; and

FIG. 4 illustrates the steps of a parking assistance method according to the invention implemented by the parking assistance system.

FIG. 1 shows, highly schematically, a driving assistance system 10, and in particular a parking assistance system for a motor vehicle (not shown). The motor vehicle comprises the following elements, which are not shown in the figures for the sake of improved clarity: a system for detecting obstacles situated in the proximity of the vehicle, for example at a distance of less than 2 m away, a parking space detection system, steering angle-controllable electric power steering, a torque-controllable engine and braking system, an automatic transmission or what is known as a “shift-by-wire” system, at least one odometric sensor, an accelerometer, a visual and audio interface and a means for activating an automatic control function or “dead man”.

The system 10 makes it possible to control the speed of the vehicle at low speed. To this end, it has a low-speed speed estimator and an acceleration estimator (which are not shown).

The system 10 comprises a module 12 for calculating or determining the acceleration of the vehicle, able to deliver an acceleration setpoint A on the basis of the speed V of the vehicle and of the distance D to an obstacle and a torque control module 14 able to calculate a braking torque setpoint C_{FF} and an engine torque setpoint C_{MF} on the basis of the acceleration setpoint A, of the speed of the vehicle V and of the gradient P of the road.

The acceleration determination module 12 calculates, in each state E of the parking assistance system 10, an acceleration setpoint A that will be transmitted to the torque control module 14 so as to continuously adjust the control of the actuators of the vehicle on the basis of the stage of the parking maneuver and of the surroundings in the proximity of the vehicle.

The states are shown in FIG. 2.

The initial state E0 of the parking assistance system corresponds to the phase of searching for a parking space. In this state E0, the parking assistance system 10 is not active, that is to say that no control is performed on the actuators. The driver of the vehicle remains completely responsible for his vehicle. To activate the parking assistance system 10, the driver has to press an activation means (not shown) for activating an automatic control function or “dead man” that is present on the dashboard of the vehicle, select the type of parking maneuver, such as for example a parallel parking maneuver, and the side of the vehicle from which the driver wishes to park the vehicle. The human-machine interface (not shown) of the vehicle then invites the driver to move forward until a parking space is detected, and then to stop the vehicle.

Once the parking space has been confirmed by the driver, the parking assistance system 10 changes to state E1, corresponding to a phase of waiting for the start of the maneuver. In this waiting phase E1, the acceleration determination module 12 calculates a negative acceleration setpoint using the following equation:

A_{E1}(k)=C (Eq. 1)
where:
A_{E1} is the acceleration setpoint calculated in state E1, expressed in m/s²;
k is the sampling time; and

C is a constant, expressed in m/s², corresponding to the acceleration target calculated by the acceleration determination module so as to ensure that the vehicle is kept at a standstill, taking into account the road and the vehicle, for example the gradient of the road and the uncertainty as to the mass of the vehicle.

In the case of parallel parking, the driver has to engage reverse gear. When reverse gear is engaged and the driver transmits the order to start the parking maneuver to the parking assistance system, this changes to state E2, corresponding to a phase of canceling the acceleration (initially defined in order to ensure that the vehicle is kept at a standstill) in which the acceleration determination module calculates a first acceleration setpoint in accordance with a fast decrease ramp and a second acceleration setpoint in accordance with a slow decrease ramp, using the following equations:

A_{E2}(k)=A_{E2}(k−1)·K·Te·K_{F} if A_{E2}(k−1)<S (Eq. 2)

A_{E2}(k)=A_{E2}(k−1)·K·Te·K_{S} (Eq. 3)
where:

A_{E2} is the acceleration setpoint calculated in state E2, expressed in m/s²;
K is the gain of the discrete integrator;
Te is the sampling period;
K_{F} is the gain of the fast ramp;
K_{S} is the gain of the fast ramp; and
S is the deceleration ramp change threshold value.

At the end of the complete cancellation of the acceleration setpoint or when the parking assistance system detects a movement of the vehicle, this changes to state E3.

To detect a movement of the vehicle, the parking assistance system comprises a movement detection module based on the “top wheels” using an internal estimator of the parking assistance system. The name “top wheels” makes reference to the output of an encoder situated at the wheel of the vehicle and that increments every X degrees of rotation of the wheel. The value X depends on the vehicle and on the size of the wheel. This encoder forms part of the odometry system of the vehicle, and there is one of these on each wheel. Upon each rotation of X degrees, there is one “top” more.

In states E1 and E2, the vehicle is immobile. In state E3, the acceleration determination module 12 calculates an acceleration setpoint A_{E3} using the following equation:

A_{E3}(k)=K_{PID.}A_{PID}(k)·+K_{FF}·A_{FF}(k) (Eq. 4)
where

$${A}_{FF} ( k ) = \frac{{dV}_{req}}{dt} \qquad ( Eq . 5 )$$

where:
A_{E3} is the acceleration setpoint calculated in state E3, expressed in m/s²;
K_{PID} is the weighting gain of the proportional integral derivative controller;
A_{PID} is the acceleration setpoint of the proportional integral derivative controller, expressed in m/s²;
K_{FF} is the weighting gain of the feedforward filter;
A_{FF} is the acceleration setpoint of the feedforward filter, expressed in m/s²; and
V_{req} is the speed setpoint of the parking assistance system corresponding to a threshold value not to be exceeded, expressed in m/s.

Upon detection of an obstacle or upon the driver's wish to resume control of his vehicle or in the event of a malfunction of one of the lateral or longitudinal actuators of the vehicle, the parking assistance system changes to state E1.

At the end of the movement, and without interruptions of the state E3, the parking assistance system changes to state E4, corresponding to the braking activation phase, in which the acceleration determination module calculates an acceleration setpoint A_{E4} using the following equation:

Q_{E4}(k)=Q_{E4}(k−1)·K·Te·K_{ab} (Eq. 6)
where:
A_{E4} is the acceleration setpoint calculated in state E4, expressed in m/s²;
K_{SB} is the gain of the braking ramp.

Once the vehicle is at a standstill and the braking ramp has ended, the parking assistance system changes to state E1, which corresponds to the phase of waiting for the next movement. In this state, the vehicle is kept at a standstill by applying a negative acceleration setpoint A_{E1}.

All of these acceleration setpoints A_{E0}, A_{E1}, A_{E2}, A_{E3} and A_{E4} are then synthesized into a single acceleration setpoint A. This is determined by virtue of the following logic, based on the states Eₓ of the system 10:
A(k)=A_{E0}(k). if E (state of the system)=E₀; or
A(k)=A_{E1}(k). if E (state of the system)=E₁; or
A(k)=A_{E2}(k). if E (state of the system)=E₂; or
A(k)=A_{E3}(k). if E (state of the system)=E₃; or
A(k)=A_{E4}(k). if E (state of the system)=E₄.

This single acceleration setpoint A is then transmitted to the torque control module 14 so as to calculate the torque setpoints necessary to control the actuators (engine and brake) of the vehicle.

The torque control module 14 comprises a module 16 for calculating the initial torque C_{MI}, C_{FI} on the basis of the acceleration setpoint A calculated by the acceleration control module 12.

The initial torque calculation module 16 comprises a converter 18 for converting the value of the acceleration setpoint A into a torque setpoint at the wheel Cr on the basis of the speed of the vehicle V and of the gradient of the road P estimated using the information supplied by the accelerometer of the vehicle (not shown) at the start of the maneuver when the vehicle is at a standstill. Depending on the gradient of the road P, the force applied to the vehicle due to this gradient, and then the corresponding torque C_{P} to be added to the torque setpoint at the wheel, are determined.

The torque setpoint at the wheel Cr is expressed using the following equation:

Cᵣ=Cₚ·+A·m·r (Eq. 7)
where:
Cᵣ is the torque setpoint at the wheel, expressed in N·m;
C_{P} is the torque corresponding to the force applied to the vehicle due to the gradient of the road, expressed in N·m;
m is the mass of the vehicle, expressed in kg; and
R is the radius of the wheel, expressed in m.

The module 16 for calculating the initial engine torque setpoint C_{MI} and the initial torque setpoint C_{FI} of the braking system furthermore comprises a saturator 20 delivering, at output, a positive component C_{MI} corresponding to the initial torque setpoint for the engine and a subtractor 22 able to subtract the previously determined engine torque component C_{MI} from the torque setpoint at the wheel Cr in order to obtain the initial torque setpoint of the braking system using a second saturator 24.

The torque control module 14 furthermore comprises a deceleration control module 26 activated only during interruption phases of the parking maneuver, such as the presence of obstacles on the trajectory, the driver canceling the maneuver or the failure of the actuators other than the braking system.

The deceleration control module 26 sends bypass orders and calculates a braking torque setpoint C_{F} on the basis of an estimated value of the acceleration A_{Est} of the vehicle obtained by differentiating the speed of the vehicle. This module 26 is based on a proportional integral controller with filtered derivative.

The torque control module 14 furthermore comprises a final torque setpoint calculation module 28 capable of arbitrating between the various torque setpoints that it receives at input so as to deliver a final engine torque setpoint C_{MF} to the wheel and a final braking torque setpoint C_{FF} to the wheel, using the following equations:

C_{MF}(k)=C_{MI}(k) if no bypass (Eq. 8)

else C_{MF}(k)=0 (Eq. 9)

C_{F}(k)=C_{FI}(k) if no bypass (Eq. 10)

else C_{FF}(k)=C_{F} (Eq. 11)
where:
C_{MF} is the final engine torque setpoint at the wheel, expressed in N·m;
C_{FF} is the final braking torque setpoint at the wheel, expressed in N·m;
C_{f} is the braking torque setpoint at the wheel calculated by the module 26, expressed in N·m.

Braking torque setpoints are thus obtained in states E₁, E₂ and E₄ of the parking assistance system, and engine and/or braking torque setpoints are obtained on the basis of the surroundings, in state E₃, of the parking assistance system.

FIG. 4 shows a flowchart for the implementation of a parking assistance method 30 for a motor vehicle.

The method 30 allows the vehicle to be parked from a traffic lane into an available parking space and allows it to leave said parking space to move onto the traffic lane.

The method 30 comprises a step 31 of determining the state E of the parking assistance system, that is to say one of the states E0 to E4 defined above.

In the initial state E0, the method comprises a step 32 of searching for a parking space.

Once the parking space has been confirmed by the driver, the method comprises a step 33 correspond to state E1 of waiting for the start of the maneuver.

When the conditions for performing the maneuver are met, that is to say, in the case of parallel parking, when reverse gear is engaged by the driver and the driver transmits the order to start the parking maneuver, the method comprises a step 34 corresponding to state E2 of canceling the acceleration, in which the acceleration determination module calculates a first acceleration setpoint in accordance with a decrease ramp for the parking assistance system.

At the end of the complete cancellation of the acceleration setpoint or when the parking assistance system 10 detects a movement of the vehicle, the method changes to step 35 corresponding to state E3.

At the end of the movement, and without interruptions of state E3, the method changes to step 36, corresponding to state E4 of braking activation, in which the acceleration determination module calculates an acceleration setpoint A_{E4}.

The method 30 furthermore comprises a step 37 of calculating an acceleration point A in each state E determined using one of equations Eq. 1 to Eq. 6 and a step of transmitting the acceleration setpoint A to the torque setpoint calculation module 14.

The method 30 comprises a step 39 of calculating an initial engine torque setpoint C_{MI} and an initial braking torque setpoint C_{FI} on the basis of the acceleration setpoint and of the gradient P of the road.

The method 30 comprises a step 40 of checking an interruption, such as for example the presence of obstacles on the trajectory, the driver canceling the maneuver or the failure of the actuators. If an interruption is detected, the detection step transmits a positive bypass value and calculates a braking torque setpoint by virtue of the proportional integral controller with filtered derivative, on the basis of an estimated value of the acceleration of the vehicle obtained by differentiating the speed of the vehicle.

The method comprises a step 41 of calculating a final torque setpoint capable of arbitrating between the various torque setpoints that it receives at input so as to deliver a final engine torque setpoint C_{MF} to the wheel and a final braking torque setpoint C_{FF} to the wheel using equations Eq. 8 to Eq. 11.

By virtue of the parking assistance system and method according to the invention, it is possible to control the longitudinal movement of the vehicle in an assisted parking maneuver while still taking into account the gradient of the road so as to ensure that the vehicle is held during the static phases of the maneuver.

1-9. (canceled)

10. A parking assistance system for a motor vehicle allowing the vehicle to be parked from a traffic lane into an available parking space and allowing the vehicle to leave said parking space to move onto the traffic lane, said motor vehicle comprising an obstacle detection system, a parking space detection system, steering angle-controllable electric power steering, a torque-controllable engine and braking system, an automatic transmission or a shift-by-wire system, at least one odometric sensor, an accelerometer, and a means for activating an automatic control function, the parking assistance system comprising:
a module configured to determine an acceleration of the vehicle and to deliver an acceleration setpoint based on the a speed of the vehicle and on a distance to an obstacle; and
a torque control module configured to calculate a braking torque setpoint and an engine torque setpoint based on the acceleration setpoint, the speed of the vehicle, and a gradient of a road.

11. The system as claimed in claim 10, further comprising operating states including:
an initial state corresponding to a phase of searching for a parking space by way of the parking space detection system,
a first state corresponding to a phase of waiting for the start of the maneuver, in which the acceleration determination module calculates a negative acceleration setpoint so as to ensure that the vehicle is kept at a standstill, taking into account the road,
a second state corresponding to an acceleration cancellation phase, in which the acceleration determination module calculates a first acceleration setpoint in accordance with a fast decrease ramp and a second acceleration setpoint in accordance with a slow decrease ramp,
a third state in which the acceleration determination module calculates an acceleration setpoint based on a feedforward filter and a proportional integral controller, and
a fourth state corresponding to a braking activation phase, in which the acceleration determination module calculates an acceleration setpoint based on a gain of a braking ramp.

12. The system as claimed in claim 11, wherein the torque control module comprises a module configured to calculate initial torque based on the acceleration setpoint calculated by the acceleration determination module in each of the first state, the second state, and the third state.

13. The system as claimed in claim 12, wherein the initial torque calculation module comprises a converter configured to convert the value of the acceleration setpoint into a torque setpoint at a wheel based on the speed of the vehicle and the gradient of the road estimated using information supplied by the accelerometer of the vehicle.

14. The system as claimed in claim 13, wherein the initial torque calculation module further comprises a saturator delivering, at output, a positive component corresponding to the initial engine torque setpoint and a subtractor configured to subtract the positive component from the torque setpoint at the wheel in order to obtain the initial braking torque setpoint.

15. The system as claimed in any one of claims 12, wherein the torque control module comprises a deceleration control module activated only during interruption phases of the parking maneuver, including at least one of the presence of obstacles on the trajectory, the driver canceling the maneuver, or the failure of the actuators other than the braking system, said deceleration control module being configured to send bypass orders and to calculate a braking torque setpoint when an interruption is detected.

16. The system as claimed in claim 15, wherein the torque control module comprises a final torque setpoint calculation module configured to arbitrate between the various torque setpoints that it receives at input so as to deliver a final engine torque setpoint to the wheel and a final braking torque setpoint to the wheel.

17. A parking assistance method for a motor vehicle allowing the vehicle to be parked from a traffic lane into an available parking space and allowing the vehicle to leave said parking space to move onto the traffic lane, said motor vehicle comprising an obstacle detection system, a parking space detection system, steering angle-controllable electric power steering, a torque-controllable engine and braking system, an automatic transmission or a shift-by-wire system, at least one odometric sensor, an accelerometer, a visual and audio interface and a means for activating an automatic control function, the method comprising:
calculating an acceleration setpoint based on a speed of the vehicle and a distance to an obstacle; and
calculating a braking torque setpoint and an engine torque setpoint based on the acceleration setpoint, the speed of the vehicle, and of a gradient of a road.

18. The method as claimed in claim 17, wherein the calculating the braking torque setpoint and the engine torque setpoint includes calculating an initial engine torque setpoint and an initial braking torque setpoint based on the acceleration setpoint and the gradient of the road, checking whether there is an interruption of the parking maneuver, and calculating a final engine torque setpoint and a final braking torque setpoint based on the initial torque setpoints and the detection of the interruption.
